(19) United States
(12) Patent Application Publication
(10) Pub. No.: US 2017/0299081 A1
(43) Pub. Date: Oct. 19, 2017

(54) ACTUATOR CONTROLLER

(71) Applicant: Aerojet Rocketdyne, Inc., Sacramento, CA (US)

(72) Inventors: Jon D. Swanson, Saugus, CA (US); Hadi Darejeh, Westlake Village, CA (US)

(21) Appl. No.: 15/518,191

(22) PCT Filed: Nov. 25, 2014
(86) PCT No.: PCT/US14/67398

§ 371 Date: Apr. 10, 2017

(51) Int. Cl. F16K 31/06; F02K 9/58; B64G 1/42; H01F 7/06; B64G 1/40

(52) U.S. Cl. CPC F16K 31/0675; H01F 7/064; B64G 1/40; B64G 1/428; F02K 9/58

(57) ABSTRACT

Systems (100) and methods (300, 500) for controlling an electromechanical valve element (116). The methods involve: building up a magnetic flux through a valve (206) of the electromechanical valve element by supplying a PWM signal to an electromechanically inductive coil (202) of the electromechanical valve element at a power level lower than a power level needed to actuate the valve. When the valve needs to be opened, an amplitude of the PWM signal is increased such that the power provided to the electromechanically inductive coil rises to a power level sufficient to actuate the valve. Notably, the valve opens when a power cycling time of the PWM signal increases beyond a minimum power required to open the valve.

### BACKGROUND

### Statement of the Technical Field

The disclosure relates to electronic systems comprising controllers for actuators. More particularly, the disclosure concerns systems and methods for controlling actuators using Pulse Width Modulation (“PWM”) frequency power control.

### Description of the Related Art

In an orbital launch vehicle, a separation system is provided for a crew capsule. The separation system is typically a solid rocket system that pulls the crew capsule away from the launch vehicle. During operation, power flows from one or more power sources to a Power Management and Distribution (“PMD”) system of the orbital launch vehicle. From there, the power is distributed to all loads. The loads include, but are not limited to, bus loads, payloads and a Service Module Propulsion (“SMP”) system. A PMD system may include a collection of circuits comprising filters, batteries, converters, isolation circuits and regulators. During operation, the PMD system outputs a regulated bus voltage that is distributed throughout the bus to the SMP system, bus loads, payloads, and battery chargers. The SMP system comprises engines, an engine power supply, and propellant tank(s). In general, the engines are configured for use on the orbital launch vehicle to assist in adjusting its position when in flight. Various valves may control the provision of propellant from one or more propellant tanks to the engines.

### SUMMARY

The present disclosure concerns systems and methods for controlling an electromechanical valve element. The methods comprise building up a magnetic flux through a valve by supplying a PWM signal to an electromechanically inductive coil of the electromechanical valve element at an average PWM current level lower than a current level needed to actuate the valve. When the valve needs to be opened, an amplitude of the PWM signal is increased such that the current provided to the electromechanically inductive coil rises to a level sufficient to actuate the valve. Notably, the valve opens when a power cycling time of the PWM signal increases beyond a minimum power required to open the valve.

Once the valve has opened, the amplitude of the PWM signal is reduced. The amplitude is reduced such that a magnetic field applied to the valve is still of a strength sufficient to retain the valve in an open position. The valve is closed by further reducing the amplitude of the PWM signal such that the magnetic field applied to the valve drops to a strength that is not sufficient to retain the valve in its open position. The supply of the PWM signal to the electromechanically inductive coil is entirely removed when the valve does not need to be actuated for a given period of time.

The present disclosure also concerns an actuator controller including an actuator and a PWM circuit interfacing with the actuator. The actuator has a pull-in average current which causes actuation of the actuator when supplied thereto. During operation, the PWM circuit may be operable to hold steady a pre-pull-in average current which has a positive non-zero value lower than the pull-in average current. The term “hold steady”, as used herein, means to supply a PWM signal which has an average current of a particular value during a given period of time.

### BRIEF DESCRIPTION OF THE DRAWINGS

Embodiments will be described with reference to the following drawing figures, in which like numerals represent like items throughout the figures, and in which:

FIG. 1 is a schematic illustration of an exemplary power system for a space vehicle.

FIG. 2 is a schematic illustration of an exemplary architecture for a valve element.

FIG. 3 is a flow diagram of an exemplary method for controlling the opening and closing of the valve of the valve element shown in FIG. 1.

FIG. 4 is a graph showing two signals useful for understanding the present disclosure.

FIG. 5 is a flow diagram of another exemplary method for controlling an actuator.

### DETAILED DESCRIPTION

The present disclosure is directed to implementing systems and methods for controlling an actuator. The speed at which the actuator (e.g., coil) engages with another mechanical element (e.g., a valve) may be faster as compared to that of conventional systems. The term “actuator”, as used herein, refers to an electro-mechanical device that moves a mechanism. In some scenarios, an element of an actuator may be a coil based solenoid, the coil of which may be moved via electromagnetic induced force. The actuator controller system may be employed in any application where fast reacting mechanical components are needed. For example, the present disclosure can also be used in medical applications, combustion systems (e.g., automotive, industrial equipment or similar industries), food processing applications and/or drug manufacturing applications. This concept can be used as a technique for an improvement of precise mass transfer of gas or liquid media by accelerating the valve to its open position (flow controlled).

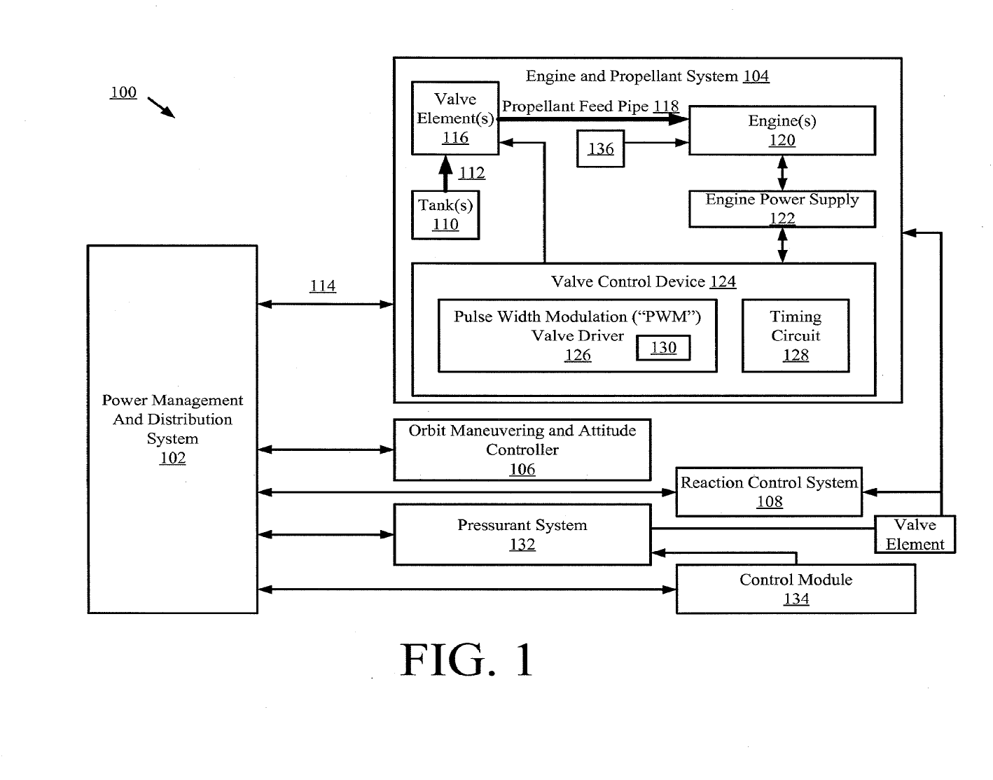

Referring now to FIG. 1, there is provided a schematic illustration of an SMP system 100 for a space vehicle that facilitates activities in a space environment, such as service to a space station, maintenance of existing satellites, placement of equipment in orbit and other activities. In this regard, the SMP system is configured to develope sufficient thrust so that the space vehicle can be maneuvered away from or toward other object.

As shown in FIG. 1, the SMP system 100 comprises a Power Management and Distribution (“PMD”) system 102, an Engine and Propellant (“E/P”) system 104, an Orbit Maneuvering and Attitude Controller (“OMAC”) 106, a Reaction Control System (“RCS”) 108, a pressurant system 132 and a control module 134. The listed components 106, 108, 132 and 134 are well known in the art, and therefore will not be discussed herein.

During operation, power flows from one or more power sources (not shown) to the PMD system 102. The power sources can include, but are not limited to, batteries, fuel cells, and/or solar cells. The PMD system 102 distributes the power to all loads 104, 106, 108, 132, 134 of the SMP system 100. In this regard, the PMD system 102 includes a collection of circuits comprising filters, batteries, converters, isolation circuits and/or regulators. The circuits are arranged to output a regulated bus voltage that is distributed throughout the bus to the loads 104, 106, 108, 132, 134, as well as battery chargers.

The E/P system 104 may include one or more engines 120 and an engine power supply 122. The engine power supply 122 is generally configured to supply power to the engine(s) 120 so as to turn it(them) “on” and “off”. In this regard, the regulated bus voltage output from the PMD system 102 is distributed to the engine power supply 122, as shown by reference number 114. The regulated bus voltage is used by the engine power supply 122 to start the engine(s) 120. At start time, the engine(s) 120 is(are) supplied propellant which is stored in one or more tanks 110. At least one valve element 116 is provided for controlling the provision of propellant from the tank(s) to the engine(s).

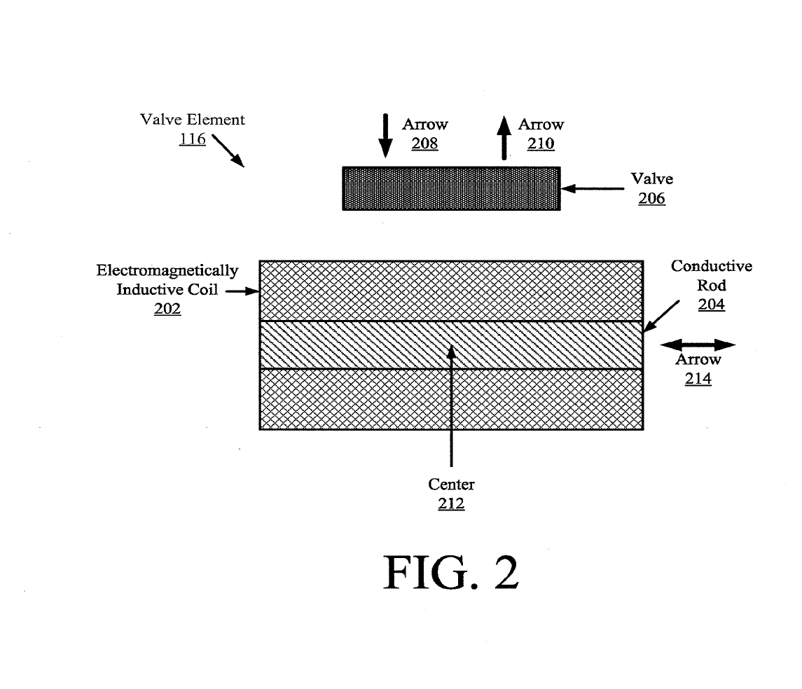

The valve element 116 includes, but is not limited to, an electromechanical valve (e.g., a solenoid valve). Electromechanical and solenoid valves are well known in the art, and therefore will not be described in detail herein. A schematic illustration of an exemplary architecture for the valve element 116 is provided in FIG. 2. The valve element 116 is described herein as comprising a normally closed valve. However, the valve element 116 may alternatively comprise a normally open valve.

As shown in FIG. 2, the valve element 116 comprises an electromagnetically inductive coil 202, a conductive rod 204 and a valve 206. The valve element 216, inductive coil 202 and/or conductive rod 204 is(are) also referred to herein as (an) actuator(s). The valve 206 is normally in a closed position. The valve 206 transitions to an open position in response to an electrical signal received from a Valve Control Device (“VCD”) 124. In this scenario, propellant is allowed to flow from the tank 110 to the engine 120 via propellant feed pipes 112 and 118. The opening and closing of the valve 206 is thereafter also controlled by the VCD 124 to regulate the flow of propellant to the engine 120 throughout its operation.

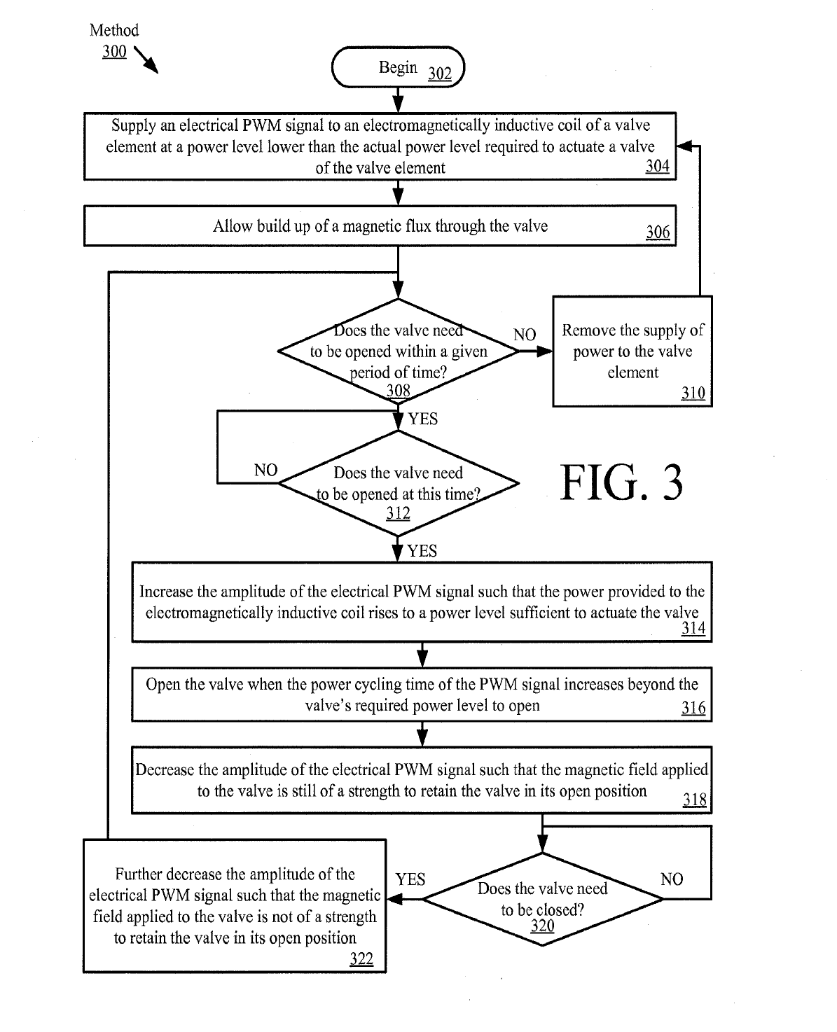

Notably, the VCD 124 implements a novel method for controlling the opening and closing of the valve of the valve element 116. A schematic illustration of the novel method 300 is provided in FIG. 3. Method 300 is described in relation to a normally closed solenoid valve scenario. As should be understood, the actuator control technique employed herein may also be used with normally open valves. In this case, method 300 may be revised accordingly.

The method 300 generally involves providing power to the electromagnetically inductive coil 202 of the valve element 116 at a cyclic on/off rate faster than the speed at which the valve 206 opens. As should be understood, the electromagnetically inductive coil 202 is wound around a conductive rod 204 which moves in and out of the coil 202 as shown by arrow 214 so as to alter the coil's inductance, and thereby provide an electromagnet. When a magnetic field of a particular strength is applied to the valve 206 by the electromagnet, the valve is caused to move in a direction shown by arrow 208 whereby the valve is transitioned from a closed state to an open state. When the strength of the magnetic field is reduced by a certain amount, the valve 206 is caused to move in a direction shown by arrow 210 whereby the valve is transitioned from the open state to the closed state.

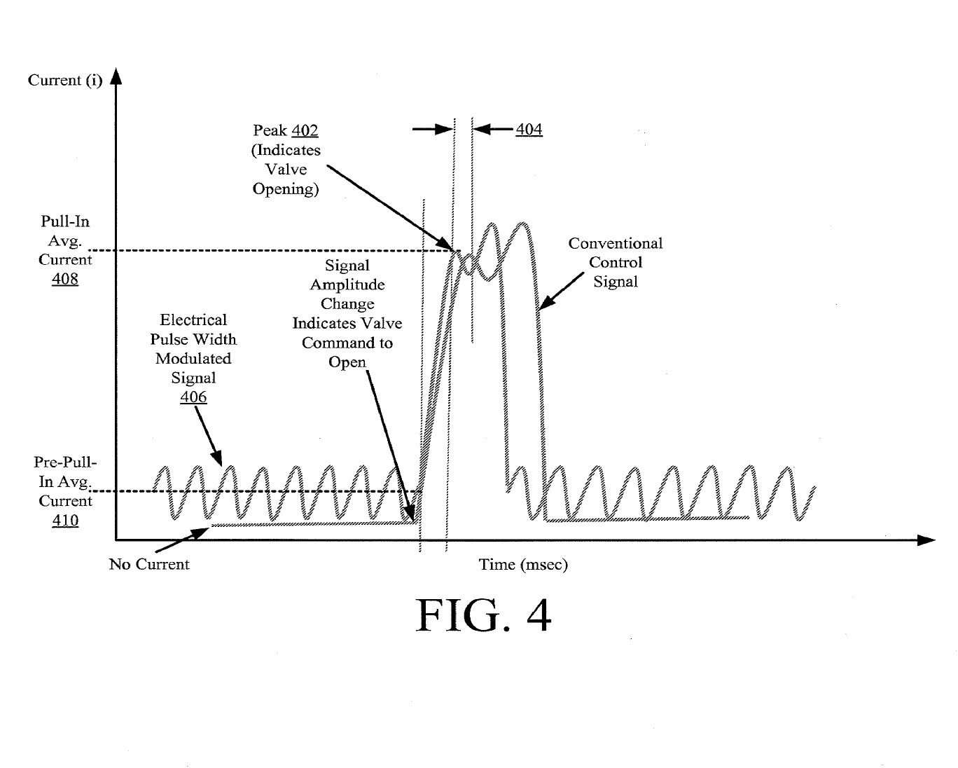

As shown in FIG. 3, the method 300 begins with step 302 and continues with step 304 where an electrical PWM signal (e.g., electrical PWM signal 406 of FIG. 4) is supplied to the electromagnetically inductive coil 202 at an PWM average current level lower than the actual PWM current level required to actuate the valve 206 of the valve element 116. This allows a buildup of magnetic flux through the valve 206, as shown by step 306.

When the valve 206 does not need to be actuated or opened within a given period of time [308:NO], step 314 is performed where the supply of power to the valve element 116 is removed. In contrast, when the valve 206 needs to be actuated or opened within a given period of time [308:YES], method 300 continues with steps 312-320 in which the valve is opened and closed at the appropriate times.

In this regard, step 312 involves determining when the valve 206 needs to be opened. At the time the valve 206 needs to be open [312:YES], step 314 is performed. Step 314 involves increasing the current (or amplitude) of the electrical PWM signal such that the power provided to the electromagnetically inductive coil 202 rises to the actual power level required to actuate the valve (e.g., as shown by peak 402 of FIG. 4). As shown by step 316, the valve 206 opens when the powered cycling time increases beyond the valve's required opening time. Once the valve has been opened, the valve is held in its open position. In this regard, the amplitude of the electrical PWM signal is decreased for power saving and heat reduction reasons, as shown by step 318. The amplitude is decreased so that the power provided to the electromagnetically inductive coil 202 falls below the power level required to actuate the valve 206, but the magnetic field is still of a strength to retain the valve in its open position. The amplitude reductions can be achieved by lowering the voltage and/or current of the PWM signal.

When the valve needs to be closed [320:YES], then step 322 is performed where the amplitude of the PWM signal is further decreased. More specifically, the amplitude of the PWM signal is decreased to a value in which the magnetic field applied to the valve 206 is of a strength that is not strong enough to retain the valve in its open position. Thereafter, method 300 returns to step 308.

As a result of the implementation of this method, the actuation speed (or opening speed) of the valve 206 is increased greatly as compared that of conventional valves (e.g., as shown by time period 404 of FIG. 4). For example, a conventional valve typically opens at 100 msec, while the valve may open at 74 to 84 msec using this method. This example reflects a 16 to 26 percent improvement in opening time of the valve. The increased actuation speed of the valve facilitates a more precise flow of propellant to the engine 120, thereby increasing the efficiency of propellant use. Additionally, such lower cost valves may be used in propulsion or engine applications. Furthermore, the electrical power surge experienced in the valve element 116 is reduced as compared to that of conventional valve circuits.

Referring again to FIG. 1, the electrical PWM signal is generated by a PWM valve driver (or PWM circuit) 126 of the VCD 124. The PWM valve driver 126 includes hardware and/or software implementing a modulation technique. The hardware can include, but is not limited to, an electronic circuit. Modulation techniques are well known in the art, and therefore will not be described herein. Any known or to be known modulation technique can be used herein without limitation. In all cases, the modulation technique controls the width of an electrical signal's pulse based on modulator signal information. The PWM signal resulting from such modulation generally comprises a chopped square wave with a fixed pulse width and frequency (e.g., of about 16 kilohertz). Notably, the frequency of the PWM signal may not be the same for two different valve control applications.

The modulation technique allows the control of the power supplied to the valve element 116. In some scenarios, the supplied power is controlled using a switch 130 disposed between the engine power supply 122 and the valve element 116. The switch 130 can include, but is not limited to, a semiconductor switch. Semiconductor switches are well known in the art, and therefore will not be described herein. Any known or to be known semiconductor switch can be used herein without limitation. The switch 130 is turned “on” and “off” at a relatively fast pace. The longer the switch 130 is “on” as compared to the “off” periods, the higher the power supplied to the valve element 116. The switching frequency is selected to be faster than the rate at which the valve 206 can open. A timing circuit 128 is provided to facilitate the turning “on” and “off” of the switch 330 at the proper times. The timing circuit 128 is designed to oscillate at a speed faster than the opening/closing speed of the valve 206.

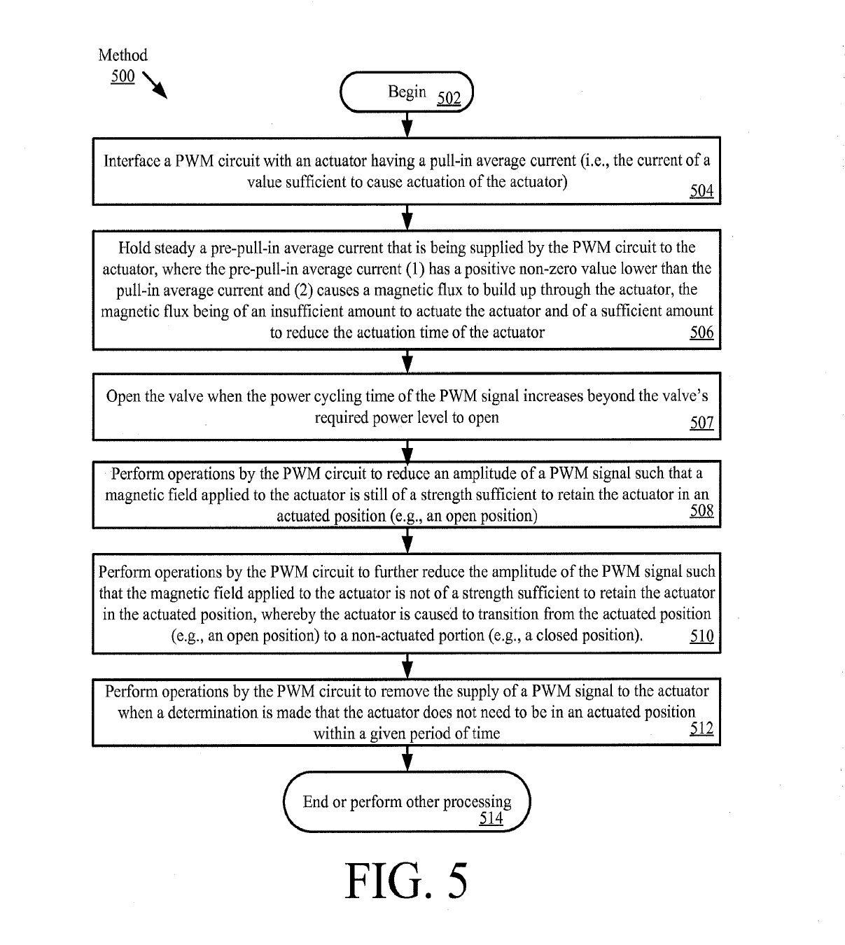

Referring now to FIG. 5, there is provided a flow diagram of another novel method 500 for controlling an actuator (e.g., the opening and closing of the valve of the valve element 116). Method 500 begins with step 502 and continues with step 504 where a PWM circuit (e.g., the PWM valve driver 126 of FIG. 1) is interfaced with an actuator (e.g., valve element 116 of FIG. 1). The actuator has a pull-in average current (e.g., pull-in average current 408 of FIG. 4) with a value sufficient to cause actuation of the actuator when supplied thereto.

During operation, the PWM circuit holds steady a pre-pull-in average current (e.g., pre-pull-in average current 410 of FIG. 4) which has a positive non-zero value lower than the pull-in average current, as shown by step 506. The term “hold”, as used herein, refers to maintaining or limit an amount of variation. The term “steady”, as used herein, refers to not fluctuating or varying widely. The pre-pull-in average current causes a magnetic flux to build up through the actuator. The magnetic flux is not of a sufficient amount to actuate the actuator, but is of a sufficient amount to increase the actuation time of the actuator (e.g., the opening/closing time of a valve). The magnetic flux is built up through the actuator by supplying a PWM signal (e.g., signal 406 of FIG. 4) to the actuator at a power level lower than a power level needed to actuate the actuator. The valve opens when the power cycling time of the PWM signal increases beyond the valve's required power level to open, as described above and as shown by step 507.

At some time later, step 508 is performed where the PWM circuit reduces the amplitude of the PWM signal such that a magnetic field applied to the actuator is still of a strength sufficient to retain the actuator in an actuated position (e.g., an open position). The amplitude can be further reduced in step 510 such that the magnetic field applied to the actuator is not of a strength sufficient to retain the actuator in the actuated position, whereby the actuator is caused to transition from the actuated position (e.g., an open position) to a non-actuated position (e.g., a closed position). The supply of a PWM signal to the actuator can be removed when a determination is made that the actuator does not need to be in an actuated position within a given period of time, as shown by step 512. Upon completing step 512, step 514 is performed where method 500 ends or other processing is performed.

We claim:

1. A method for controlling an electromechanical valve element, comprising:
building up a magnetic flux through a valve of the electromechanical valve element by supplying a Pulse Width Modulation (“PWM”) signal to an electromechanically inductive coil of the electromechanical valve element at a PWM average current level lower than a PWM current level needed to actuate the valve; and
increasing an amplitude of the PWM signal when the valve needs to be opened such that an average power provided to the electromechanically inductive coil rises to a power level sufficient to actuate the valve.

2. The method according to claim 1, further comprising removing the supply of the PWM signal to the electromechanically inductive coil when a determination is made that the valve does not need to be opened within a given period of time.

3. A method for controlling an electromechanical valve element of a propulsion system, comprising:
building up a magnetic flux through a valve of the electromechanical valve element by supplying a Pulse Width Modulation (“PWM”) signal to an electromechanically inductive coil of the electromechanical valve element at a PWM average current level lower than a PWM current level needed to actuate the valve; and
allowing propellant to flow to an engine of the propulsion system by increasing an amplitude of the PWM signal such that an average power provided by the electromechanically inductive coil rises to a power level sufficient to actuate the valve.

4. The method according to claim 3, wherein the amplitude of the PWM signal is increased when it is determined that the valve needs to be opened.

5. The method according to claim 5, further comprising removing the supply of the PWM signal to the electromechanically inductive coil when it is determined that the valve does not need to be opened within a given period of time.

6. A system, comprising:
an actuator having a pull-in average current that causes actuation of the actuator when supplied thereto; and
a Pulse Width Modulation (“PWM”) circuit interfacing with the actuator;
wherein the PWM circuit holds steady a pre-pull-in average current which has a positive non-zero value lower than the pull-in average current.

7. The system according to claim 6, wherein the pre-pull-in average current causes a magnetic flux to build up through the actuator which is not of a sufficient amount to actuate the actuator, but is of a sufficient amount to decrease the actuation time of the actuator.

8. The system according to claim 7, wherein the magnetic flux is built up through the actuator by supplying a PWM signal to the actuator at a power level lower than a power level need to actuate the actuator.

9. The system according to claim 6, wherein the PWM circuit further removes a supply of a PWM signal to the actuator when a determination is made that the actuator does not need to be in an actuated position within a given period of time.

10. The system according to claim 6, wherein actuation of the actuator causes propellant to flow to an engine of the system.
